(19) United States
(12) Patent Application Publication
(10) Pub. No.: US 2021/0016971 A1
(43) Pub. Date: Jan. 21, 2021

(54) MOUNTING PLATE FOR CONVEYOR COMPONENTS INCLUDING GREASE EGRESS

(71) Applicant: Laitram, L.L.C., Harahan, LA (US)

(72) Inventors: Drew Downer, Caledonia, MI (US); Michael Hendrik DeGroot, Rockford, MI (US)

(21) Appl. No.: 17/043,316

(22) PCT Filed: Apr. 3, 2019
(86) PCT No.: PCT/US2019/025547

§ 371 Date: Sep. 29, 2020

Related U.S. Application Data
(60) Provisional application No. 62/656,440, filed on Apr. 12, 2018.

(51) Int. Cl. B65G 13/11; B65G 39/12

(52) U.S. Cl. CPC B65G 13/11; B65G 2207/26; B65G 2201/0202; B65G 39/12

(57) ABSTRACT

An end assembly for a conveyor comprises opposing mounting plates machined from steel billet and including upper openings for mounting a drive between the mounting plates and a grease egress channel below the upper openings for directing grease from a grease-filled bearing in the upper opening to the exterior of the end assembly.

### RELATED APPLICATIONS

The present application claims priority to U.S. Provisional Patent Application Ser. No. 62/656,440, filed Apr. 12, 2018 and entitled “Mounting Plate for Conveyor Components Including Grease Egress”, the contents of which are herein incorporated by reference.

### FIELD OF THE INVENTION

The present invention relates to power-driven conveyors. More particularly, the invention relates to infeed and outfeed assemblies for a conveyor to transition conveyed items onto and off of the conveyor.

### BACKGROUND OF THE INVENTION

Power-driven conveyors are used to convey items. At the indeed and outfeed ends, mounting plates may be used to mount various conveyor components, such a sprockets, rollers or other components. Grease-filled bearings may be used to connect a rotating component, such as a drive shaft for a sprocket, with a fixed component, such as a mounting plate. However, it is not desirable for grease to enter the stream of conveyed products.

### SUMMARY OF THE INVENTION

An end assembly for a conveyor comprises opposing mounting plates including openings for mounting a drive between the mounting plates, a grease egress below the openings for directing grease from a bearing in the opening to the exterior of the end assembly.

According to one aspect, a mounting plate for conveyor components is provided. The mounting plate comprises a planar portion extending in height from an upper edge to a lower edge, in length from a rear edge to a front edge and in thickness from an inner surface to an outer surface. A first opening for a bearing is formed in the planar portion. A grease egress channel is below and in communication with the first opening, the grease egress channel extending to the outer surface of the planar portion.

According to another aspect, a conveyor comprises a frame including opposing mounting plates at an end of the conveyor, each mounting plate including an upper opening for mounting a drive shaft and a grease egress channel for channeling grease from the upper opening to an outer surface of the mounting plate and a drive assembly mounted in the upper openings. The drive assembly comprises a drive shaft mounted on bearings received in the upper openings and a drive mounted on the drive shaft.

According to another aspect, a method of manufacturing a mounting plate for conveyor components comprises the steps of providing a steel billet extending in height from an upper edge to a lower edge, in length from a rear edge to a front edge and in thickness from an inner surface to an outer surface, machining a bearing opening through the steel billet extending from the outer surface to the inner surface, and machining a grease egress channel below and in communication with the bearing opening. The grease egress channel has an opening in the outer surface of the steel billet.

### BRIEF DESCRIPTION OF THE FIGURES

FIG. 1 is an isometric view of a conveyor end assembly including mounting plates having a grease egress according to an embodiment of the invention;

FIG. 2 is an isometric view of the mounting plates and back plate of an embodiment of the invention;

FIG. 3 is an interior view of a mounting plate of an embodiment of the invention;

FIG. 4 is an exterior view of the mounting plate of FIG. 3.

### DETAILED DESCRIPTION OF THE INVENTION

A conveyor system includes a mounting plate for conveyor components having a grease egress. The invention will be described below relative to certain illustrative embodiments, though the invention is not limited to the illustrative embodiments.

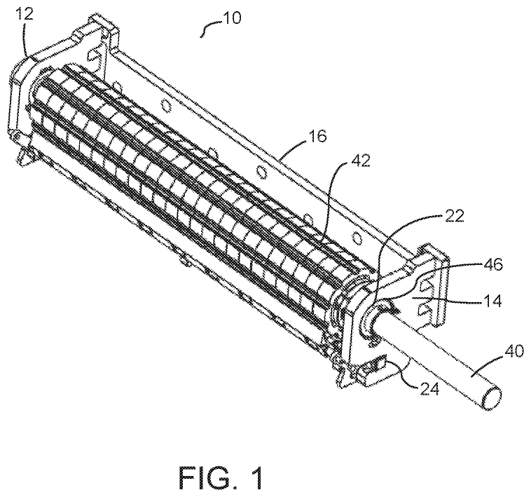

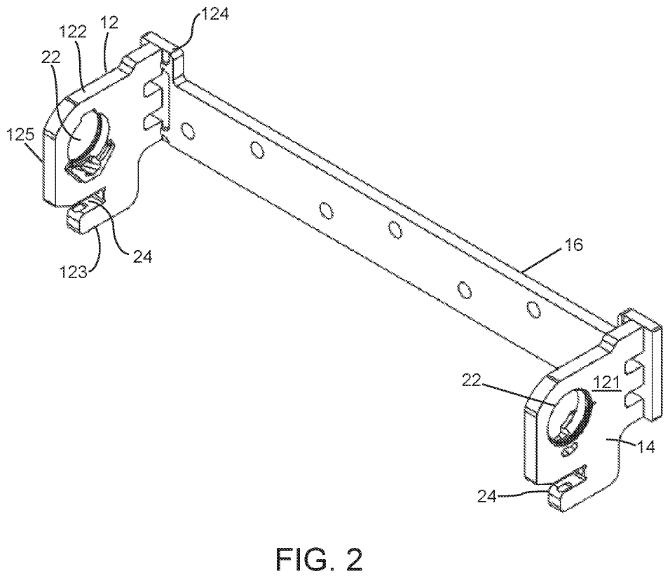

FIG. 1 illustrates a portion of a drive end of a conveyor belt system. The illustrative drive end assembly 10 includes a pair of spaced apart, opposing mounting plates 12, 14 for mounting various conveyor components and forming a drive end of a conveyor. Each mounting plate extends in height from an upper edge 122 to a bottom edge 123, in length from a rear edge 124 to a front edge 125 and in thickness from an inner surface 120 to an outer surface 121, as shown in FIG. 2.

The illustrative mounting plates 12, 14 are connected by a back plate 16. Each mounting plate includes an upper opening 22, for receiving a drive shaft 40, on which a full-width sprocket 42 or other conveyor drive is mounted. A motor or other means drives the sprocket 42. The drive shaft 40 is mounted in a bearing 46 at each end. Each bearing 46 is seated in an opening 22. The upper opening 22 is substantially circular in cross-section with an upper cleaning window facing the inner surface 120 of the plate, though the invention is not so limited.

Lower openings 24 are used to mount a position limiter—scraper assembly 26. A suitable position limiter—scraper assembly 26 is described in U.S. Pat. Nos. 9,296,565, 9,555,971, US Patent Application Publication Number 20170158434, and WO2017205135, the contents of which are herein incorporated by reference. The illustrative lower openings 24 comprise open slots extending from the front of the plate 12 or 14 to an intermediate dosed end for receiving a mounting shaft of the position limiter-scraper assembly 26.

The illustrative mounting plates 12, 14 are machined from stainless steel billet, but any suitable manufacturing process or material can be used. A stock piece of billet can be provided, then openings 22, 24 and other features can be machined to form the final mounting plate.

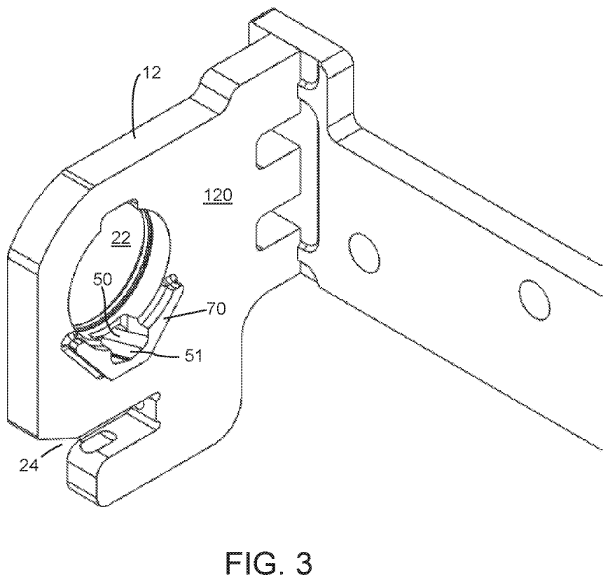

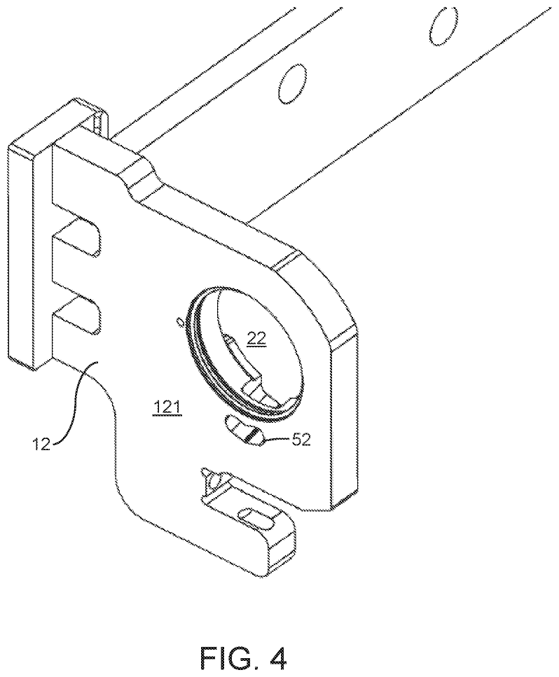

Referring to FIGS. 3 and 4, the mounting plates 12, 14 further include a grease egress for capturing grease from a bearing 46 and transmitting it to the outside 121 of the mounting plate 12, 14, preventing grease from entering the food stream or the path of the conveyed product, In one embodiment, the grease egress comprises a channel 50 in a mounting plate having a first end open to the bottom of the opening 22 in which the bearing is mounted. The illustrative channel 50 is also open to the interior of the mounting plate 12. The channel 50 has a second end in the outer surface 121 of the mounting plate 12.

The bottom wall 51 of channel 50 is curved, with a nadir corresponding to the middle of opening 22, The bottom wall 51 slants down towards the outer surface 121 of the plate 12 to catch and direct great away from an interior region. The illustrative opening 52 in the outer surface 121 of the mounting plate 12 is kidney-shaped, with a curved bottom edge, curved side edges and a curved upper edge. in one embodiment, curvature of channel 50 matches the curvature of the bottom of the opening 22, but the invention is not so limited.

A catch pan (not shown) can be placed adjacent to the opening 52 to trap grease exiting the channel 50,

In one embodiment, the opening 22 includes an additional lip 70 on the inner surface to accommodate a bearing that is wider than the thickness of the mounting plate 12 or 14. The lip 70 extends the bottom of the inner wall of the opening 22 to support a bearing. The channel 50 extends into the lip, as shown, Smaller bearings can he mounted flush to the inside of the plate and the added lip will not be required.

The scope of the claims is not meant to be limited to the details of the described exemplary embodiments.

What is claimed is:

1. A mounting plate for conveyor components, comprising:
a planar portion extending in height from an upper edge to a lower edge, in length from a rear edge to a front edge and in thickness from an inner surface to an outer surface;
a first opening for a bearing formed in the planar portion; and
a grease egress channel below and in communication with the first opening, the grease egress channel extending to the outer surface of the planar portion.

2. The mounting plate of claim 1, further comprising a second opening below the grease egress channel for mounting a position limiter assembly to the mounting plate.

3. The mounting plate of claim 1, wherein the grease egress channel has a curved bottom surface that slants downwards towards the outer surface.

4. The mounting plate of claim 1, further comprising an inner lip extending inward from the first opening for accommodating a bearing

5. The mounting plate of claim 4, wherein the grease egress channel extends into the inner lip.

6. The mounting plate of claim 1, wherein the grease egress channel forms a kidney-shaped opening in the outer surface.

7. A conveyor, comprising:
a frame including opposing mounting plates at an end of the conveyor, each mounting plate including an upper opening for mounting a drive shaft and a grease egress channel for channeling grease from the upper opening to an outer surface of the mounting plate; and
a drive assembly mounted in the upper openings, the drive assembly comprising a drive shaft mounted on bearings received in the upper openings and a drive mounted on the drive shaft.

8. The conveyor of claim 7, further comprising a position limiter assembly mounted between lower openings in the mounting plates.

9. The mounting plate of claim 7, wherein the grease egress channel is below and in communication with the upper opening and has a curved bottom surface that slants downwards towards the outer surface of the mounting plate.

10. The mounting plate of claim 7, wherein each mounting plate comprises an inner lip extending inward from the upper opening for accommodating a bearing.

11. The mounting plate of claim 10, wherein the grease egress channel extends into the inner lip.

12. The mounting plate of claim 7, wherein each grease egress channel forms a kidney-shaped opening in the outer surface of the associated mounting plate.

13. A method of manufacturing a mounting plate for conveyor components, comprising the steps of:
providing a steel billet extending in height from an upper edge to a lower edge, in length from a rear edge to a front edge and in thickness from an inner surface to an outer surface;
machining a bearing opening through the steel billet extending from the outer surface to the inner surface; and
machining a grease egress channel below and in communication with the bearing opening, the grease egress channel having an opening in the outer surface of the steel billet.

14. The method of claim 13, further comprising the step of machining a second opening below the grease egress channel for mounting a position limiter assembly to the mounting plate.

15. The method of claim 13, wherein the grease egress channel has a curved bottom surface that slants downwards towards the outer surface.
